(19) United States
(12) Patent Application Publication
(10) Pub. No.: US 2009/0167882 A1
(43) Pub. Date: Jul. 2, 2009

(54) ELECTRONIC DEVICE AND OPERATION METHOD THEREOF

(75) Inventors: Li-Hsuan Chen, Taipei (TW); Hung-Young Hsu, Taipei (TW); Chu-Chia Tsai, Taipei (TW)

Correspondence Address: QUINTERO LAW OFFICE, PC, 2210 MAIN STREET, SUITE 200, SANTA MONICA, CA, 90405, US

(73) Assignee: WISTRON CORP., TAIPEI HSIEN (TW)

(21) Appl. No.: 12/175,199

(22) Filed: Jul. 17, 2008

(30) Foreign Application Priority Data
Dec. 28, 2007 (TW) TW96150828

(51) Int. Cl. H04N 5/228

(52) U.S. Cl. 348/222.1; 348/E05.031

(57) ABSTRACT

An operation method for operating an electronic device having an image capture unit is disclosed. The method comprises the following steps. An input image of an object having first and second sub images is first acquired from the image capture unit. Next, the acquired first and second sub images are recognized to obtain information regarding outlines or positions of the first and second sub images. A corresponding control instruction is generated according to the relative relationship between the outlines or positions of the first and second sub images. Then, at least one operation corresponding to the generated control instruction is performed.

### CROSS REFERENCE TO RELATED APPLICATIONS

This Application claims priority of Taiwan Patent Application No. 96150828, filed on Dec. 28, 2007, the entirety of which is incorporated by reference herein.

### BACKGROUND OF THE INVENTION

1. Field of the Invention

The invention relates to electronic devices and related operation methods, and more particularly, to operation methods for use in an electronic device having an image capture unit.

2. Description of the Related Art

Driven by user requirements, more and more electronic devices, especially handheld or portable electronic devices such as smart phones, personal digital assists (PDAs), and tablet PCs or Ultra Mobile PCs (UMPCs), comprise various peripherals such as a video camera, for improving user convenience.

In general, a user issues a control instruction to the electronic device through the input unit such as a keyboard, a mouse or a touch-sensitive screen. A user may also issue a control instruction to the electronic devices by voice-controlling. The recognition capability of voice-controlling, however, depends on environmental noise at the time of recognition. Thus, should environmental noise be great enough, the recognition capability of voice-controlling would be relatively low and a wrong instruction may be interpreted or an instruction may not be executable. In addition, some electronic devices may use a video camera for performing video talk over a network or photographing images.

### BRIEF SUMMARY OF THE INVENTION

A simple operation method for use in an electronic device having an image capture unit is provided to intuitively and quickly issue commonly used or complex control instructions by users, so as to improve convenience in use and control of the electronic device.

An embodiment of an operation method for operating an electronic device having an image capture unit is provided. The method comprises the following steps. (a) An input image of an object having first and second sub images are acquired from the image capture unit. (b) The acquired first and second sub images are recognized to obtain information regarding outlines or positions of the first and second sub images. (c) A corresponding control instruction is generated according to the relative relationship of the outlines or positions of the first and second sub images. (d) At least one operation corresponding to the generated control instruction is performed.

An embodiment of an electronic device is also provided. The electronic device comprises an image capture unit, a recognition unit and a processing unit. The image capture unit acquires an input image of an object having first and second sub images. The recognition unit recognizes positions of the acquired first and second sub images and generates a corresponding control command according to the relative relationship between the positions of the first and second sub images. The processing unit performs at least one operation corresponding to the generated control instruction.

Another embodiment of an operation method for operating an electronic device having an image capture unit is further provided. The method comprises the following steps. A first image and a second image different from the first image are first acquired from the image capture unit. The acquired first and second images are then recognized and a corresponding control instruction is generated according to a variational relationship between the first and second images. At least one operation corresponding to the generated control instruction is accordingly performed.

### BRIEF DESCRIPTION OF THE DRAWINGS

The invention can be more fully understood by reading the subsequent detailed description and examples with reference to the accompanying drawings, wherein:

FIG. 1 shows a block diagram of an embodiment of an electronic device 100 according to the invention;

FIG. 2 is a flowchart illustrating an embodiment of an operation method according to the invention;

FIGS. 3A to 3C are schematics showing embodiments of input images according to the invention;

FIG. 4 is a schematic illustrating an embodiment of an operation method according to the invention;

FIG. 5 is a flowchart illustrating another embodiment of an operation method according to the invention;

FIG. 6 is a flowchart illustrating yet another embodiment of an operation method according to the invention;

FIGS. 7A and 7B are schematics showing embodiments of 2D images according to the invention; and

FIGS. 8A to 8C are schematics showing embodiments of 3D images according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide an operation method for use in an electronic device having an image capture unit (e.g. camera or video camera), such as a smart phone, a personal digital assist (PDA), and a tablet PC or an Ultra Mobile PC (UMPC). An input image is acquired by the image capture unit and the acquired image is then recognized. Then, the recognized result of the acquired image (still or motion image) is converted to generate a corresponding control instruction based on a predefined relationship corresponding thereto so as to direct the electronic device to perform at least one operation corresponding to the generated control instruction.

The embodiments provide intuitive operation methods to issue control instructions to the electronic devices by analyzing interaction between a user's hand and his (her) face or by a motion of the user's hand. An image corresponding to a control instruction may be inputted to the electronic device through the image capture unit (e.g. video camera), and then the inputted image would be recognized and the control instruction corresponding to the recognized image would then be obtained. Accordingly, an operation corresponding to the obtained control instruction would be performed. Therefore, simplifying the operation process.

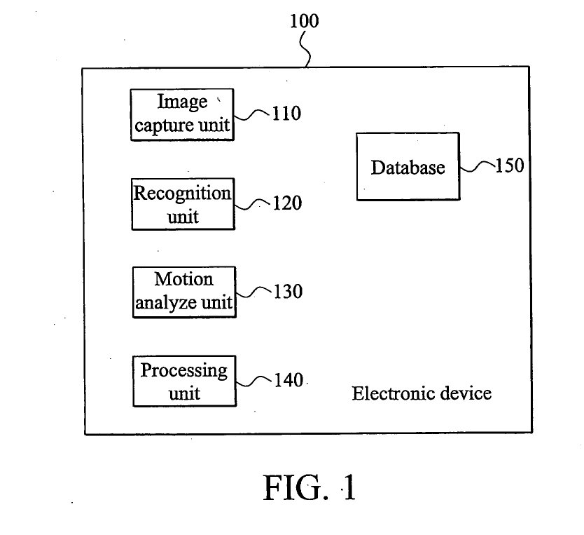

FIG. 1 shows a block diagram of an embodiment of an electronic device 100 according to the invention. The electronic device 100 at least comprises an image capture unit 110, a recognition unit 120, a motion analyzer unit 130, a processing unit 140 and a database 150. The electronic device 100 may be, for example, any electronic device that has an image capture unit, such as a smart phone, a personal digital assist (PDA), a tablet PC, and an Ultra Mobile PC (UMPC) or the like.

The image capture unit 110 acquires an input image of an object and transfers the acquired image to the recognition unit 120 for image recognition of the acquired image. The input image at least comprises still and motion images in which the still image includes first and second sub images while the motion image represents a motion image performing a specific motion on a 2D (two-dimension) or 3D (three-dimension) plane. The recognition unit 120 may effectively perform an image recognition operation to recognize positions and outlines of the acquired first and second sub images, and obtain the relationship corresponding to the positions of the first and second sub images. The method for recognizing the outlines and positions of the first and second sub images by the recognition unit 120 are detailed in the following. Note that only one image capture unit is utilized to acquire the first and second sub images in this embodiment. However, in other embodiments, more than one image capture unit may be utilized to acquire the first and second sub images. In this case, sub images may be acquired by different image capture units and all of the acquired sub images may be sent to the database 150 for comparison at the same time.

The processing unit 140 may obtain the relative relationship between positions of the first and second sub images based on the recognized result from the recognition unit 120, and then inspect the database 150 to generate a corresponding control instruction and perform at least one operation corresponding to the generated control instruction. In other embodiments, operations for obtaining the relative relationship between positions of the first and second sub images and further inspecting the database 150 to generate a corresponding control instruction may be performed by the recognition unit 120 instead of the processing unit 140. As a result, the processing unit 140 may perform operations corresponding to the control instruction generated by the recognition unit 120. The database 150 may comprise a plurality of predetermined images in which each predetermined image would include the first and second sub images, and the relative positions of the first and second sub images in one predetermined image may be different from those in another predetermined image. Each predetermined image corresponds to a control instruction and the control instruction may be pre-inputted by users. For example, a user interface may be provided for allowing a user to input each of the required control instructions and setup an image representing an instruction corresponding thereto in advance and the inputted data would be stored into the database 150. Therefore, while receiving an acquired image, the recognition unit 210 may compare the acquired image to images pre-stored in the database 150 and inspect whether any matched image is found, and if so, output the control instruction corresponding to the found image as the corresponding control instruction to the processing unit 140. An image is normally recognized as being matched, if positions and outlines of the sub images therein are the same as those of the acquired image.

For example, a user may easily make a motion of putting his (her) forefinger on his (her) lips to remotely issue an instruction for turning on the mute function. This motion would be recognized and converted to a mute instruction and the mute instruction would then be sent to the processing unit 140. Upon receiving the mute instruction, the processing unit 140 would perform related operations for turning the mute function, such as turning off the volume of the speaker.

The electronic device 100 may further comprise a display unit (not shown) for providing various displays for user operation. In this embodiment, the display unit may display a message indicator which corresponds to the control instruction represented by the input image for user indication. The user may determine and ensure whether the control instruction received by the electronic device 100 is correct or not based on the displayed message indicator.

In this embodiment, a user interface capable of performing the operation method of the invention may be activated by the user by a specific method such as hot key activation from a hardware source, automatic activation, voice control activation or key activation from a software source. Activation of the user interface may be user defined or based on customer requirement. Hot key activation from a hardware source may be achieved by pressing at least one specific key or button for activation of a desired function. Automatic activation may be activated or enabled when detecting a specific motion of a user's hand and disabled when the detected specific motion of the user's hand has disappeared. Voice control activation may be achieved or disabled by a user using his (her) voice to issue an instruction or cancel the instruction. Key activation from a software source may be achieved by control from a software source.

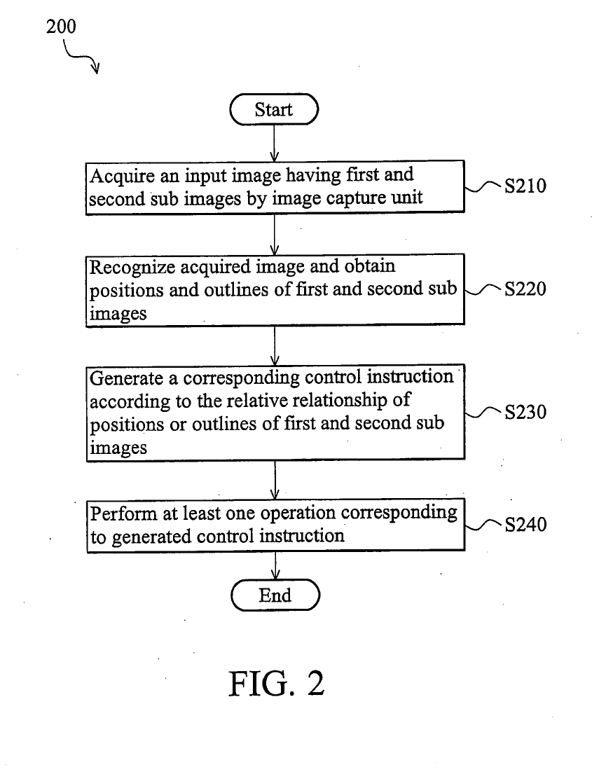

FIG. 2 is a flowchart 200 illustrating an embodiment of an operation method according to the invention. First, in step S210, an input image having first and second sub images is acquired by the image capture unit. In step S220, a recognition operation is performed on the acquired image to recognize and obtain positions and outlines of first and second sub images. In step S230, a corresponding control instruction is generated according to the relative relationship of positions or outlines of the first and second sub images. In step S240, at least one operation corresponding to the generated control instruction is performed.

It is to be noted that, for illustration purpose, in the following embodiments, the electronic device 100 is assumed to be a personal computer (PC) and the image capture unit 110 is assumed to be a video camera, but it is not limited thereto.

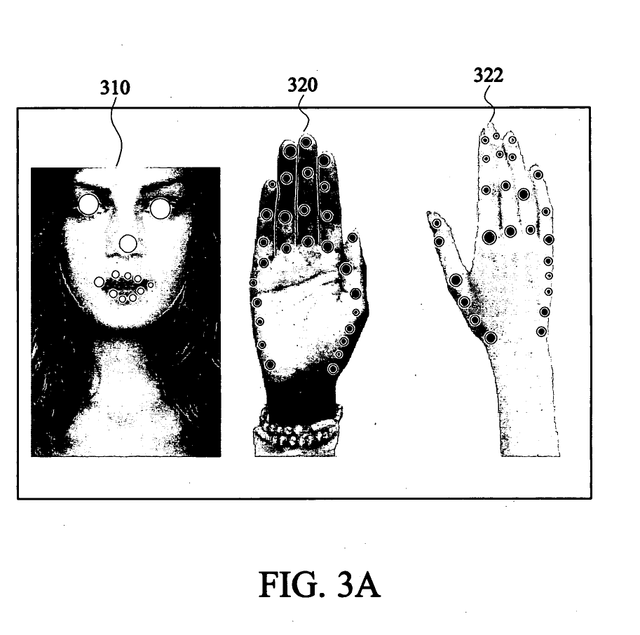

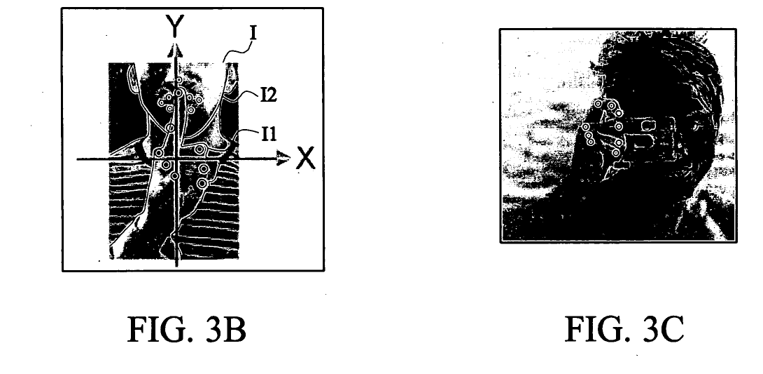

FIGS. 3A to 3C are schematics showing embodiments of input images according to the invention. Referring to FIG. 3A, positions of a face image 310 and hand (gesture) images 320 and 330 are located, respectively. Referring to FIG. 3B, input image I comprises a hand image I1 and a face image I2. By determining the relative positions between the hand image I1 and face image I2, different control instructions may be issued or made. As shown in FIG. 3B, a user remotely makes a motion, by putting his forefinger on his lips to issue a control instruction for turning on the mute function. Similarly, as shown in FIG. 3C, the user remotely puts his forefinger in front of his eyes and forms a hand gesture representing pressing the shutter of the camera to issue a control instruction for turning on the image capturing function or turning on the web camera.

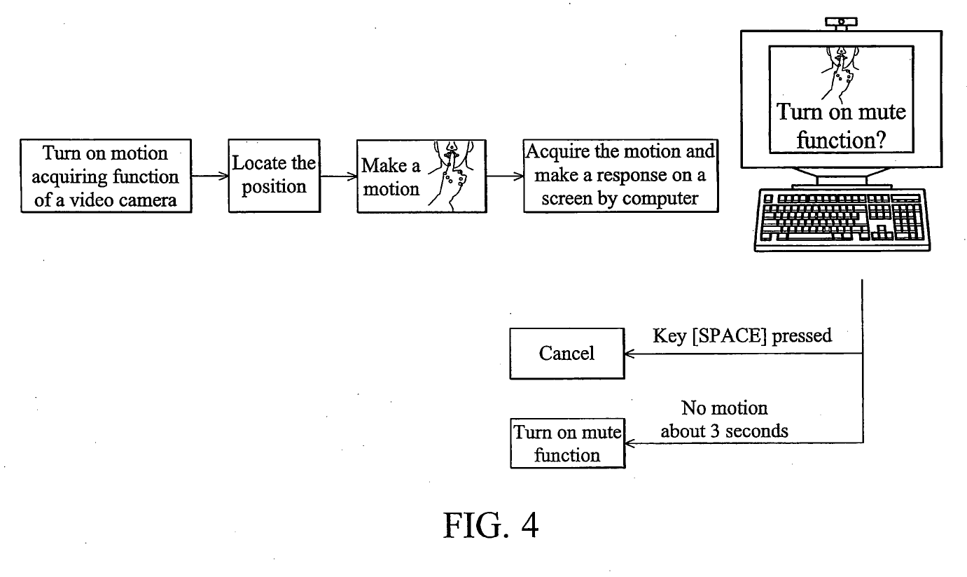

FIG. 4 is a schematic illustrating an embodiment of an operation method according to the invention. First, a motion acquiring function of a video camera is turned on or activated by using a specific method such as pressing a predetermined function key. Thereafter, a locating procedure for locating the position of the image is performed. In this embodiment, the locating procedure is utilized to locate the relative positions between a user's hand and a user's face images so as to obtain bench marked images of the hand image and the face image. Based on the acquired images, the locating of the hand image may comprise locating a shape of a hand and locating a hand gesture. The difference in locating a shape of a hand and locating a hand gesture is the accuracy of the outline acquired by the video camera. During the locating procedure, the hand will open and several locating points are acquired within a reasonable range of the video camera in which both sides of the hand (front and rear side) and the face is required to be correctly located. It is to be noted that it is unnecessary to repeat the locating procedure once it has already been done. In this case, the locating procedure may be skipped and a later step for motion recognition may be performed.

After the locating procedure is completed, bench marked images of the hand and face images can be obtained. Then, a motion corresponding to a required operation may be made in front of the video camera. Note that it is assumed that the mute function required is to turn on the mute function and that the motion corresponding to turning on the mute function is a motion of putting his (her) forefinger on his (her) lips. Next, the user makes a motion by putting his (her) forefinger on his (her) lips to issue an instruction to turn on the mute function. Then, the computer acquires the input image through the video camera and sends the acquired image to the recognition unit 120 for image recognition. The motion of putting the user's forefinger on the user's lips, will be recognized by the recognition unit 120 and a corresponding control instruction for turning on the mute function would be generated. Thus, a message indicator “whether to turn on the mute function?” corresponding to the generated control instruction will be displayed in the display unit. At the same time, the user may determine whether the control instruction received by the electronic device is correct based on the displayed message indicator. If the user requires to cancel the proposed execution of turning on the mute function or a recognition result for the acquired image is incorrect, a specific key [SPACE] may be pressed to inform the computer to cancel the operation and revert back to the previous step for allowing the user to once again acquire the image. On the other hand, a confirmation instruction may be inputted according to a predefined rule if the user requires the mute function to be turned on. In this embodiment, the user may stand in front of the video camera for three seconds without any motion to ensure and implement the operation of turning on the mute function. Thereafter, the computer would perform related operations for turning on the mute function, such as turning off the volume of the speaker, according to the control instruction.

Note that outlines of different hand images (e.g. hand gesture) may represent different control instructions even if the position of the hand image and face image are overlapped. Therefore, the outline of the hand image has to be recognized during the recognition operation. For example, the user may make a motion of keeping his five fingers opened in front of his mouth to issue a control instruction to turn off the mute function which is slightly similar to the turning on the mute function.

Moreover, the user may make a dynamic motion to issue a specific control instruction. In this case, the database 150 may comprise a plurality of predefined motion images. Each of the predefined motion images correspond to a control instruction that is pre-inputted by the user.

When the input image is a motion image performing a specific motion on a 2D or 3D plane, a recognition result for the acquired motion image is sent to the processing unit 140 by the recognition unit 120. After receiving the recognized motion image, the processing unit 140 sends the recognized motion image to the motion analyzer unit 130 for motion determination. The motion analyzer unit 130 may compare the recognized motion image to predefined motion images pre-stored in the database 150 and inspect whether a matched motion image is found, and if so, output the control instruction corresponding to the found motion image.

A motion may be recognized as a 2D plane relative image or a 3D plane relative image based on a difference in the static and dynamic range of the video camera. The motion of a 2D plane relative image may be achieved by making a simple motion without considering the layers presented on the screen. The motion of a 3D plane relative image may, however, consider layers presented on the screen and a distance between the video camera and the hand may be detected and determined, to obtain more than two kinds of level distances for response to layer relation of files or folders presented on the display unit.

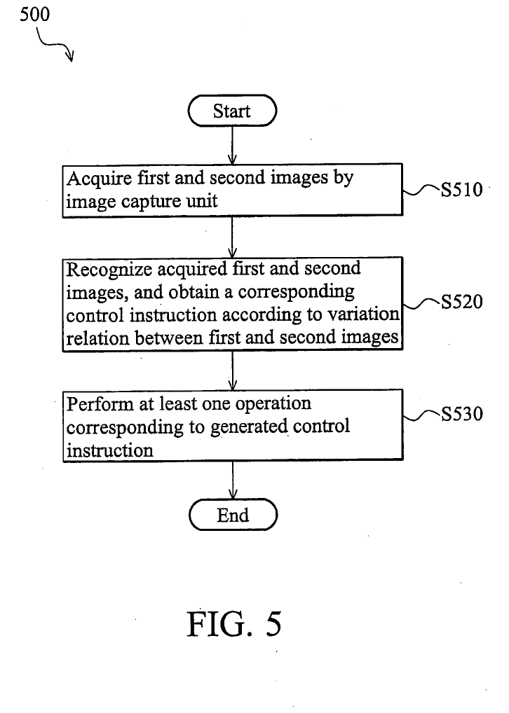

FIG. 5 is a flowchart 500 illustrating another embodiment of an operation method according to the invention. First, in step S510 at least first and second images are acquired by image capture unit. Note that the acquiring step may be achieved by acquiring a plurality of related images within a predetermined time period and then applying the acquired images for forming a 2D or 3D image. Then, in step S520, the acquired first and second images are recognized and a corresponding control instruction is obtained/generated according to a variational relationship between the first and second images. In some embodiments, the variational relationship between the first and second images may comprise a positional difference between the first and second images, a moving track formed by the first and second images, image sizes of the first and second images, a motion of a motion image formed by the first and second images, a variation of the first and second images on a 2D plane or a 3D plane and so on. Each kind of the variational relationship may correspond to a different control instruction, Therefore, the processing unit 140 is capable of obtaining a corresponding control instruction based on the variational relationship between the first and second images.

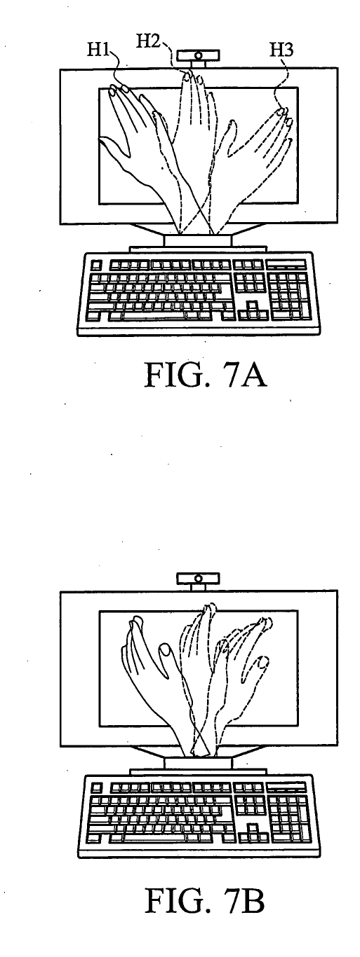

FIGS. 7A and 7B are schematics showing embodiments of 2D images according to the invention, illustrating a predefined dynamic motion for inputting a control instruction. Referring to FIG. 7A, a motion for issuing a power-off control instruction to power off the computer is illustrated. Referring to FIG. 7B, a motion for issuing a page-turning control instruction to turn pages is illustrated. As shown in FIG. 7A, the palm of the hand is waving left and right in a direction facing the video camera like a goodbye gesture. When the video camera acquires the repeated occurrences and fixed motion on the 2D plane, operations for powering off the computer (e.g. save currently used files and powering off) will be performed. As shown in FIG. 7A, the video camera may periodically acquire images H1 to H3 thereby recognizing that the input image is a repeated occurrence image and a fixed motion on a 2D plane.

Referring to FIG. 7B, laterally, a hand is aimed at the video camera and a motion of turning a page swept across the screen represents a request for page turning. A motion of page turning from left to right or from right to left may represent a request to turn to a next page or a previous page, respectively. The aforementioned page turning motion may only be applied in applications supporting page turning such as a web browser or a text editor (e.g. Word or PDF files).

In some embodiments, if the user makes a motion on a 3D plane, after the video camera position has been located, a distance between the video camera and the object (e.g. user's hand) may also be utilized to determine whether the object is far away or close to the screen based on an image size of the acquired image, so as to determine layers of the displayed screen in a display unit. In some embodiments, a distance between the video camera and the object and a fixed hand gesture may be combined to issue a set of control instructions.

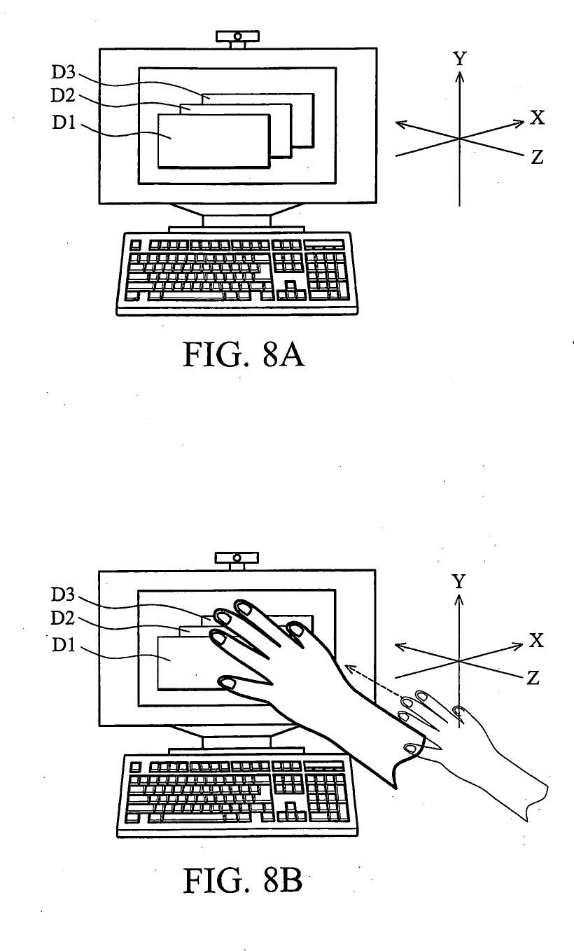

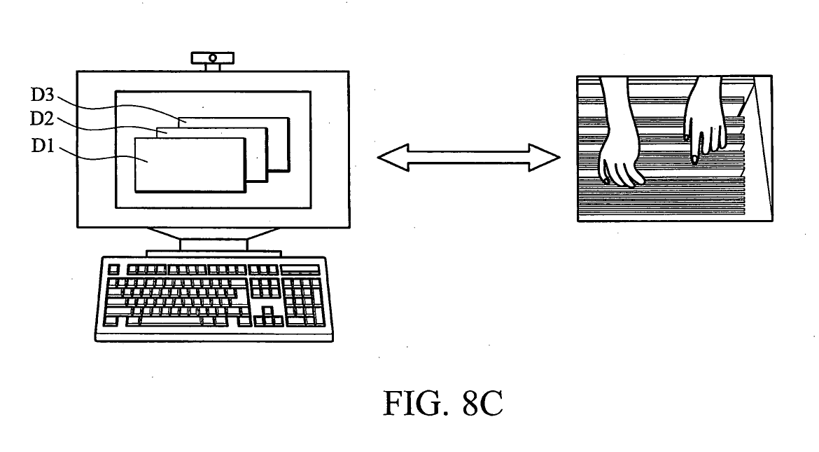

FIGS. 8A to 8C are schematics showing embodiments of 3D images according to the invention. As shown in FIG. 8A, when there is constant motion of a user's hand captured by the video camera and a predefined repeated motion is represented along a distance axis (e.g. along the Z-axis), it may represent a file seize operation for files displayed on the screen. The aforementioned file seize operation may be applied to switching a heap of piled folders, pictures, applications or files with the same attributes, for example.

In some embodiments, image size of the input image acquired by the video camera may be utilized to obtain a distance between the video camera and the acquired image and be further utilized to input a specific control instruction. Referring to FIG. 8B, a motion of rummaging around the front and rear by a user's hands is illustrated. This motion may be widely applied in various fields. By using a motion image representing a motion of rummaging around acquired by the video camera, the order of layers stacked on the screen can be represented. A motion of rummaging around the front represents selecting a file from an inner layer (e.g. D3 of FIG. 8A) while a motion of rummaging around the rear (in a direction toward to the user) represents selecting a file from an outer layer (e.g. D1 of FIG. 8A). During the rummaging operation, a selected file on the screen will be visually indicated and displayed for user indication.

In some embodiments, inputting of the control instruction may be achieved by analyzing image size of the input image acquired by the video camera to obtain a distance between the video camera and the acquired image along with variations in hand gestures. Referring to FIG. 8C, files placed in the back will be selected when a user's hand is moving into the screen (i.e. moving toward the screen), and a file may be confirmed to be chosen if it is touched and a motion of seizing an object is made by the user.

After the processing unit 140 obtains the control instruction, in step S530, related operations corresponding to the obtained control instruction will then be performed.

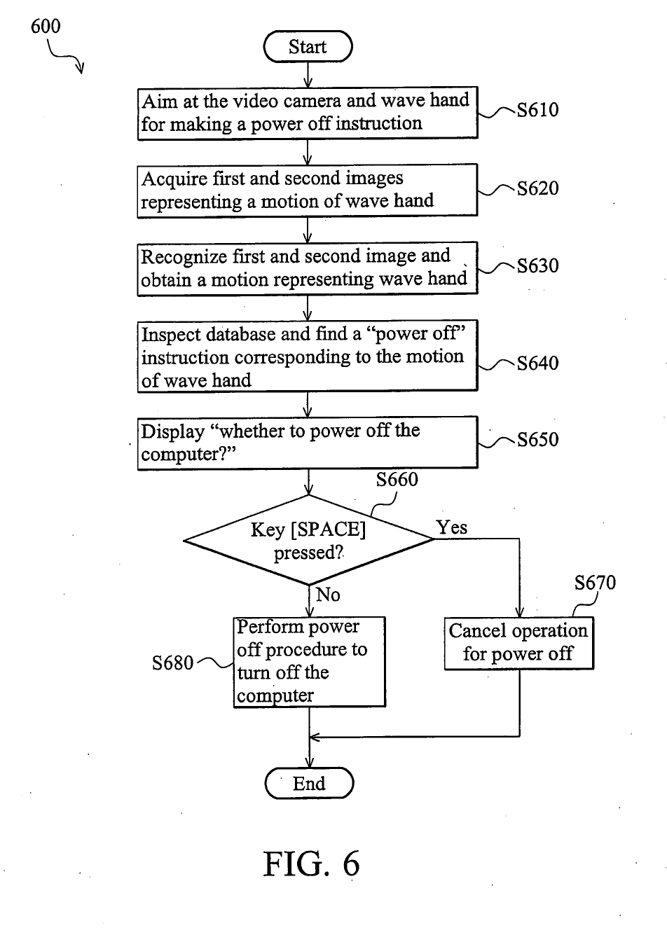

FIG. 6 is a flowchart 600 illustrating an embodiment of an operation method according to the invention. In step S610, a user aims at the video camera and waves his hand left and right for issuing a power-off instruction. In step S620, the image capture unit acquires first and second images representing a motion of a waving hand. In step S630, first and second images are recognized to obtain a motion representing a waved hand. In step S640, images stored in the database are inspected and a corresponding control instruction, i.e. a power-off instruction, corresponding to the motion of the waved hand is found. In step S650, a message indicator “whether to power off the computer?” is accordingly displayed and it is determined whether to perform the power-off instruction. In step S660, it is detected whether a key [SPACE] is pressed. If so (Yes in step S660), i.e. the user may require to cancel the power-off instruction or may have obtained an erroneous recognition result, the operation for powering off the electronic device may be cancelled (step S670). If the key [SPACE] has not been pressed for a predetermined time period (e.g. few seconds) (No in step S660), i.e. the power-off instruction is correct, a related power off procedure is then performed to turn off the computer (step S680).

In summary, with the operation method of the invention, the user can intuitively make a motion (such as in combination with his hand and face or moving his hand) to issue an instruction to the electronic device through the image capture unit when needed, thereby effectively simplifying use for users when issuing required instructions and improving user convenience.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. An operation method for operating an electronic device having an image capture unit, comprising:
(a) acquiring an input image of an object having first and second sub images from the image capture unit;
(b) recognizing the acquired first and second sub images to obtain information regarding outlines and positions of the first and second sub images;
(c) generating a corresponding control instruction according to the relative relationship of the outlines or positions of the first and second sub images; and
(d) performing at least one operation corresponding to the generated control instruction.

2. The operation method of claim 1, further comprising:
providing bench marked images of the first and second sub images; and
recognizing the outlines and positions of the first and second sub images based on the bench marked images of the first and second sub images.

3. The operation method of claim 1, wherein the step of generating the corresponding control instruction further comprises:
providing a database having a plurality of predetermined images, wherein each of the predetermined images corresponds to a control instruction;
finding a predetermined image, wherein the outlines and positions of the found predetermined image are the same as that of the first and second sub images from the database; and
outputting a control instruction corresponding to the found predetermined image.

4. The operation method of claim 3, further comprising:
pre-inputting a control instruction and an image corresponding thereto, wherein the image comprises the first and second sub images; and
storing the control instruction and the corresponding image into the database.

5. The operation method of claim 1, further comprising:
activating the image capture function by using a specific method, wherein the specific method comprises hot key activation from a hardware source, automatic activation, voice control activation and key activation from a software source.

6. The operation method of claim 1, wherein the first sub image is a hand gesture image and the second sub image is a face image.

7. The operation method of claim 6, further comprising:
generating the control instruction based on a positional relationship between the hand gesture image and the face image and the outline of the hand gesture image.

8. The operation method of claim 1, further comprising:
displaying a message indicator which corresponds to the control instruction;
determining whether the control instruction is correct according to the displayed message indicator; and
if the control instruction is not correct according to the displayed message indicator, pressing a specific key to cancel the operation corresponding to the control instruction.

9. The operation method of claim 1, wherein the control instruction comprises at least instructions corresponding to the image capture unit.

10. An electronic device, comprising:
an image capture unit, acquiring an input image of an object having first and second sub images;
a recognition unit, recognizing positions of the acquired first and second sub images and generating a corresponding control instruction according to the relative relationship between the positions of the first and second sub images; and
a processing unit, performing at least one operation corresponding to the generated control instruction.

11. The electronic device of claim 10, further comprising a motion analyzer unit, wherein when the input image is a motion image, the motion analyzer unit determines the corresponding control instruction according to a motion generated by the motion image.

12. The electronic device of claim 10, further comprising a database storing a plurality of predetermined images, wherein each of the predetermined images corresponds to a control instruction.

13. The electronic device of claim 10, further comprising a display unit for displaying a message indicator which corresponds to the control instruction.

14. The electronic device of claim 10, wherein the first sub image is a hand gesture image and the second sub image is a face image.

15. The electronic device of claim 14, wherein the processing unit further generates the control instruction based on a positional relationship between the hand gesture image and the face image and the outline of the hand gesture image.

16. The electronic device of claim 10, wherein the image capture unit is a camera or a video camera.

17. An operation method for operating an electronic device having an image capture unit, comprising:
acquiring a first image and a second image different from the first image from the image capture unit;
recognizing the acquired first and second images and generating a corresponding control instruction according to a variational relationship between the first and second images; and
performing at least one operation corresponding to the generated control instruction.

18. The operation method of claim 17, wherein the step of generating the corresponding control instruction further comprises:
generating the corresponding control instruction based on a positional difference between the first and second images.

19. The operation method of claim 17, wherein the step of generating the corresponding control instruction further comprises:
generating the corresponding control instruction based on a moving track formed by the first and second images.

20. The operation method of claim 17, wherein the step of generating the corresponding control instruction further comprises:
generating the corresponding control instruction based on image sizes of the first and second images.

21. The operation method of claim 17, wherein the step of generating the corresponding control instruction further comprises:
generating the corresponding control instruction based on repeated variations of the first and second images within a predefined time period.

22. The operation method of claim 17, wherein the step of generating the corresponding control instruction further comprises:
generating the corresponding control instruction based on a variation of the first and second images on a 2D plane, wherein the first and second images form a 2D motion image.

23. The operation method of claim 17, wherein the step of generating the corresponding control instruction further comprises:
generating the corresponding control instruction based on a variation of the first and second images on a 3D plane, wherein the first and second images form a 3D motion image.
